(19) United States
(12) Patent Application Publication
(10) Pub. No.: US 2013/0340200 A1
(43) Pub. Date: Dec. 26, 2013

(54) Rinser for Cleaning Containers

(71) Applicant: KRONES AG, Neutraubling (DE)

(72) Inventor: Norbert Kindl, Tegernheim (DE)

(21) Appl. No.: 13/904,772

(22) Filed: May 29, 2013

(30) Foreign Application Priority Data
Jun. 21, 2012 (DE) 102012210504.2

(51) Int. Cl. B08B 9/30

(52) U.S. Cl. CPC B08B 9/30
USPC 15/302

(57) ABSTRACT

A rinser for cleaning containers, includes a linear conveyor path for conveying the containers; lances which are inserted into the containers for supplying at least one cleansing agent; and at least one suction device for sucking off the supplied cleansing agent from the containers. The lances are arranged at a closed cyclic transport path, and the transport path includes a linear section which corresponds to the conveyor path for supplying the cleansing agent.

### FIELD OF THE INVENTION

The invention relates to a rinser for cleaning containers having the features of the preamble of patent claim 1.

### BACKGROUND

Rinsers are usually employed for cleaning the interior of a container from foreign particles. In the process, a cleansing agent is introduced into the interior of the container and also sucked off again through the mouth of the container. The cleansing agent is, for example, ionized air. The ionized air neutralizes the prevailing electric field inside the containers, and the foreign particles are guided out of the container with the aid of the air flow.

U.S. Pat. No. 5,487,200, for example, shows a rinser in which a tubular lance is introduced through the container's mouth to just above the container's bottom and ionized air is pressed into the container. The ionized air rinses the container, flows around the lance and out of the mouth of the container and is sucked off through a suction device. In this device, the containers are transported on a linear conveyor belt, and the conveyor belt is stopped for each container for the cleaning step. It turned out that in this arrangement, the container throughput is limited by the stopping of the containers on the conveyor belt.

U.S. Pat. No. 2,644,188 shows a rinser for containers wherein the containers are continuously transported on a linear conveyor belt and cleaned via a nozzle and a suction device. Here, the nozzle does not submerge into the container's mouth, and thus the containers can be transported continuously, however, the possibilities of guiding the air flow are restricted, and the cleaning effect is hardly calculable.

US 2007/0240784 also shows a rinser where the containers are also transported continuously and upside down along a linear conveyor path. Here, the containers are, in a two-stage process, first rinsed with ionized air by means of a nozzle/suction device and subsequently blown out with air from a high-speed nozzle to achieve a better cleaning effect. Here, the nozzles neither submerge into the container, and thus the cleaning effect is, also in this case, difficult to calculate.

U.S. Pat. No. 5,265,298 also shows a comparable device where the containers are transported on a linear conveyor path over an air nozzle and a suction device which neither submerge into the container. Here, the containers additionally pass through a protective chamber which is filled with purified air to avoid a recontamination of the containers.

DE 101 40 906 shows a rinser for cleaning preforms where a lance is introduced through the mouth into a preform to just above the bottom. Here, the preform is also cleaned with ionized air which is sucked off again above the mouth of the preform. Here, the preforms are received in a carousel, and the lances are moved into and out of the preforms in synchronism with the transport in the carousel via a mechanism. Here, it is possible to obtain a calculated cleaning effect and to simultaneously continuously convey the containers. However, it turned out that with this rinser, the construction is expensive and requires a lot of components.

It is an object of the disclosure to provide a rinser which requires less parts, is less expensive and simultaneously permits a continuous transport of the containers and a calculable cleaning effect.

### SUMMARY

According to some aspects, the disclosure achieves this object with a rinser for cleaning containers with the features of the preamble of claim 1 having the features of the characterizing part, according to which the lances are arranged at a closed cyclic transport path and the transport path comprises a linear section which corresponds to the conveyor path for supplying the cleansing agent.

By the lances being arranged at a closed cyclic transport path, the lances can be continuously moved further along the transport path and do not have to be stopped. By the transport path comprising a linear section corresponding to the conveyor path for supplying the cleansing agent, the containers can be conveyed with a linear conveyor path which is of a particularly simple design. In other words, the containers do not have to be transferred from a typically linear conveyor path to carousel-like conveyor devices to permit a continuous cleaning with the lances. In the corresponding linear region of the conveyor path and the transport path, the lances can be guided into and out of the containers while they are being conveyed. Thereby, a directed air flow for cleaning the interior of the containers can be obtained, thus achieving a calculable cleaning effect.

The rinser for cleaning containers can be arranged in a beverage processing plant. The rinser can in particular be embodied for cleaning the containers after the manufacturing process. The containers can comprise bottles, cans and/or preforms. The containers can be designed to receive gaseous, liquid, solid and/or pasty products. The rinser can precede a beverage filling line. The rinser can also precede a stretch-blow machine by which in particular preforms are reshaped into a bottle shape.

The conveyor path can be a conveyor belt or a pitch belt. The pitch belt can comprise two belts arranged in parallel with respect to each other which in particular move at the same conveyor speed. The conveyor path can be designed to receive the containers in a regular pattern. The pattern can in particular correspond to the distance of the lances with respect to each other.

The lances can be essentially straight tubes. The lances can include a nozzle at an outlet end for the cleansing agent. The lances can be embodied with a shifting mechanism along their axes to guide the lances into and out of the containers. The lances can be embodied to ionize the cleansing agent. The lances can include an ionizing needle for generating an arc.

The cleansing agent can be a liquid cleansing agent, a vaporous cleansing agent and/or a gas, in particular compressed air. The cleansing agent can also be hydrogen peroxide. The cleansing agent can be a component required for cleaning. The cleansing agent can be provided for reducing the number of foreign particles inside the container.

The suction device can be embodied with a pump or a blower. The suction device can be arranged in the region around the mouth of the container.

The lances can be arranged in a regular pattern at the closed cyclic transport path. This pattern can in particular correspond to the container pattern of the linear conveyor path. The lances can be arranged perpendicularly to the direction of motion of the transport path. The transport path can include a motion mechanism which introduces the lances into the containers.

The transport path can be embodied in the region of the linear section such that the longitudinal axes of the lances correspond to the mouths of the containers during conveyance. Thereby, the lances can be continuously driven into and out of the mouth of the container in the region of the linear section, and cleaning can be accomplished without changing the position of the lance's longitudinal axis with respect to the container mouth. In other words, during the transport of the containers in the linear section, one lance can be disposed opposite to each container mouth.

The conveyor path can include container seats by which the containers are continuously conveyed. By the container seats, the containers can be particularly easily received through the conveyor path and are thus located within a fixed pattern during cleaning. The container seats can be embodied as segmental recesses in a pitch belt. The container seats can equally be embodied as circular recesses in a belt.

In the rinser for cleaning containers, the transport path can include at least one toothed belt at which the lances are arranged. Thanks to the design as a toothed belt, the transport path can be constructed particularly simply and thus inexpensively.

The toothed belt can run over at least two belt rollers, the linear section of the transport path being formed with a run of the toothed belt located between the two belt rollers. In other words, the toothed belt can be tensioned over at least two belt rollers. The belt rollers and the toothed belt can include corresponding teeth that engage with each other. The belt rollers can in particular have the same diameter. The lances disposed at the toothed belt can move on the linear section of the transport path in the region of the run located between the two belt rollers. This permits a particularly simple construction of the linear section of the transport path.

The transport path can include guide elements in which the lances are mounted such that they can shift along their longitudinal axes. Thereby, the mechanism can have a simpler design to guide the lances into and out of the containers. The guide elements can be arranged at the toothed belt, in particular at regular distances. The guide elements can contain a cylindrical bore forming a sliding bearing for the lances. The guide elements can be embodied such that the longitudinal axis of the lances are arranged in parallel to the belt's surface and perpendicularly to the direction of transport.

The lances can include guide rollers which roll in a cam curve for controlling their longitudinal movement. Thereby, the mechanism can be designed particularly simply to guide the lances into and out of the containers. The cam curve can be a groove in a component fixed with respect to the direction of transport. The guide roller can be designed with a ball bearing. The axis of the guide roller can be arranged perpendicularly with respect to the longitudinal axis of the lance.

The cam curve can be designed to be height adjustable for adjusting an immersion depth of the lances into the containers. By the height adjustment of the cam curve, the immersion depth of the lances into the containers can be regulated such that the latter project as far as possible into the container during cleaning, but do not collide with the container's bottom. By the height adjustment, the rinser can be adjusted to different container heights. Height adjustment can be automatic, where container data, in particular container heights, and corresponding maximal and/or optimal immersion depths of the lances are stored in a database. The height adjustment of the cam curve can be integrated with a height adjustment of the transport path.

The lances can be connected with a rotary distributor via hoses and/or cables, where in particular the rotary distributor is synchronized with the transport path via a transmission. The rotary distributor permits a distribution of the cleansing agents and/or of the supply line for controlling the lances. The supply lines can include electric, pneumatic and/or hydraulic lines. The hoses can be connected with an inlet end of the lances for supplying them with cleansing agent. The rotary distributor can be coupled to the transport path such that one rotation of the rotary distributor corresponds to one rotation of the closed cyclic transport path.

The suction device can include suction hoods associated with the lances which are in particular embodied for the height adjustment to the conveyor path. By this, an even better cleaning effect can be achieved. The suction hoods can be driven in synchronism with the lances. The suction hoods can be embodied such that they suck off the cleansing agent from a gap between the lance and the container mouth. For height adjustment, the suction hoods can be guided in a height adjustable groove. The height adjustment of the suction hoods can be embodied to be automatic, where in particular container data are stored in a database.

The suction hoods can be connected with the guide elements of the transport path to be height adjustable. Thereby, the guide elements fulfill the guiding function both for the lances and for the suction hoods and are thus efficiently used. The suction hoods can be connected to the guide elements via guide rods. The guide elements can include cylindrical bores which form a sliding bearing for the guide rods. The guide rods can be arranged in parallel to the lances.

The conveyor path and the transport path can be connected with a transmission, and the transmission can be driven via a drive motor. By the common transmission, the conveyor path and the transport path can be particularly easily synchronized. Moreover, the same drive motor can be employed both for the transport path and for the conveyor path. The transmission can be embodied such that the conveyor path and the transport path move along the linear section at the same speeds. The drive motor can be an electric motor.

Further features and advantages of the disclosure will be illustrated below with reference to the exemplary figures. In the drawings:

### BRIEF DESCRIPTION OF THE DRAWINGS

FIG. 1 shows a perspective view of a rinser according to the disclosure for cleaning containers;

FIG. 2 shows a perspective view of a linear conveyor path and a closed cyclic transport path of the rinser according to the disclosure of FIG. 1;

FIG. 3 shows a perspective partial view of the lances with guide rollers and a cam curve of the rinser according to the disclosure of FIG. 1;

FIG. 4 shows a sectional view of the rinser according to the disclosure of FIG. 1 in a lateral representation;

FIG. 5A shows a detailed view of the rinser according to the disclosure of FIG. 1 illustrating the height adjustment of the lances and the suction hoods in a sectional view at a first immersion depth; and

FIG. 5B shows the rinser illustrating the height adjustment of the lances and the suction hoods at a second immersion depth.

### DETAILED DISCLOSURE

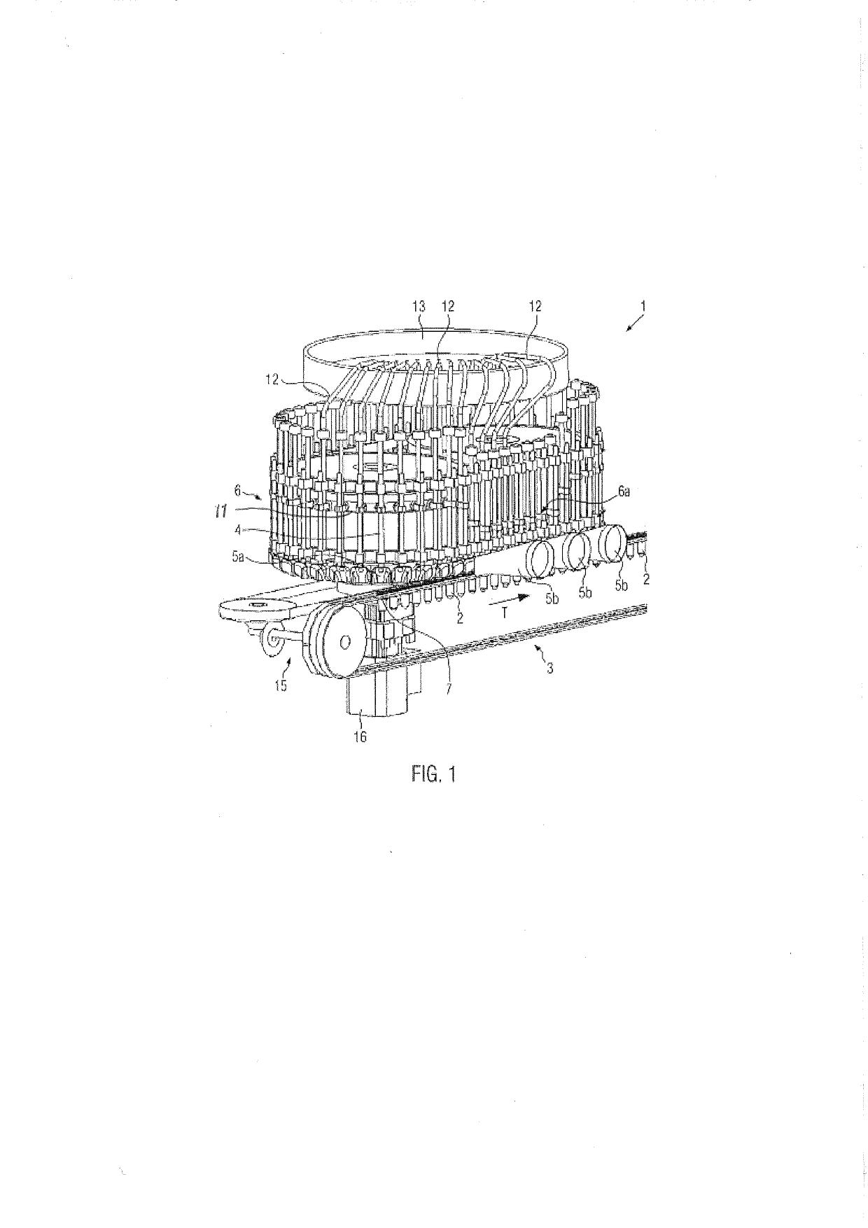

FIG. 1 shows a perspective representation of a rinser 1 according to the disclosure for cleaning containers 2. One can see a rinser 1 which cleans the containers 2 on the linear conveyor path 3 while these are being continuously conveyed.

The containers 2 are received in a fixed pattern with the linear conveyor path 3. The containers 2 are here, for example, preforms for a stretch-blow machine. The conveyor path 3 is designed as a pitch belt which is driven via a roller. The containers 2 are received in container seats 7 between the two belts, such that said seats 7 form a regular pattern.

Simultaneously, an arrangement of lances 4 is located at the cyclically closed transport path 6, the transport path 6 comprising a linear section 6a which corresponds to the conveyor path 3 for supplying a cleansing agent. The lances 4 are here arranged in the same pattern as the containers 2 on the conveyor path 3. In the region of the linear section 6a of the transport path 6, the lances 4 are lowered down into the containers 2, so that the cleansing agent can be guided into them. At this point in time, the cleansing agent is compressed air which can be introduced into the lances 4. This compressed air is preferably ionized only at the lance mouth. This is achieved by an internal ionizing needle, where an electric voltage is applied between the ionizing needle and the lance 4 and generates an electric arc which subsequently ionizes the compressed air flowing through. By this procedure, the ionization of air is actively generated only at the place where it is used, so that a possible discharge in the conveyor path 3 can be avoided. As an alternative, a liquid or vaporous cleansing agent can also be introduced into the containers 2. During the lowering of the lances 4 into the containers 2, the containers 2 and the lances 4 move at the same speed in the direction of transport T. Here, each lance 4 corresponds to one container 2, so that each lance 4 can be lowered into the corresponding container 2 during transport. One can see that in the region 6a, the lances 4 are lowered down into the containers 2 and press the ionized air into them there. Within the container 2, the ionized air flows past and outside the lance 4, upwards and out of the container mouth and is sucked off there by the suction devices 5a, 5b.

The suction devices 5a, 5b include suction hoods 5a which are associated with the lances 4. Here, the suction hoods 5a move along with the lances 4 and past the suction funnels 5b. In the region of the suction funnels 5b, the air flow coming from the containers 2 is then received by the suction hoods 5a and forwarded through the funnels 5b to an extract fan (not represented here).

One can also see in FIG. 1 that above the transport path 6, a rotary distributor 13 is located which distributes compressed air to the lances 4 via hoses 12. Here, the rotary distributor 13 rotates along with the transport path 6 such that both perform one rotation cycle within the same time.

One can also see a transmission 15 in FIG. 1 which is driven by a drive motor 16. Here, the transmission 15 drives both the conveyor path 3 and the closed cyclic transport path 6. By the transmission 15, the conveyor path 3 and the transport path 6 are synchronized such that on the one hand they move at the same path speed and the lances 4 are arranged in the region of the linear conveyor path 3 each opposite to the containers 2.

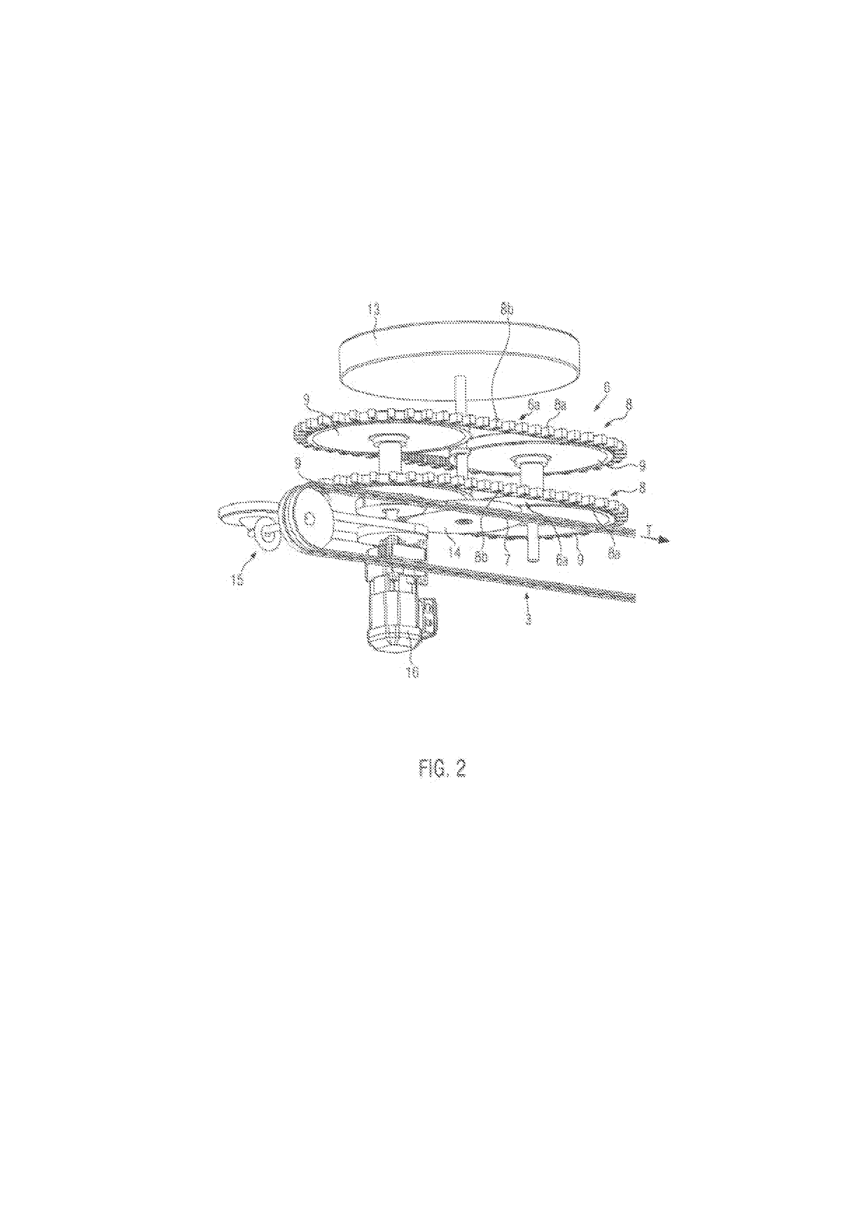

FIG. 2 shows a perspective view of a linear conveyor path 3 and a closed cyclic transport path 6 of the rinser 1 according to the disclosure of FIG. 1. The corresponding assemblies are here shown in an isolated way. One can see that the conveyor path 3 and the linear section 6a of the transport path 6 are embodied correspondingly.

The transport path 6 is here embodied as a synchronous belt drive. Here, two toothed belts 8 are tensioned in parallel to each other via two belt rollers 9 each. Each toothed belt 8 has a tape-like belt 8b which comprises, on its inner side, a number of teeth which engage with the belt rollers 9 and can be driven thereby. On the outer side of the tape-like belts 8b, there are guide elements 8a for receiving the lances 4 (not represented here) and the guide rods for the suction hoods 5b (not represented here). By the guidance of the lances 4 with two toothed belts 8 arranged in parallel, each lance 4 is stabilized across the direction of transport T. Here, for one lance 4, corresponding guide elements 8a of the two toothed belts 8 are each located at the same level with respect to the direction of transport T.

The belt rollers 9 are driven via the transmission 15 and the drive motor 16. The transmission 15 synchronizes here the conveyor path 3 and the transport path 6, as already described above. Moreover, above the transport path 6, a rotary distributor 13 is arranged which is synchronized with the transport path 6 via the transmission 14.

The complete arrangement is synchronized such that the guide elements 8a are each located opposite the associated container seats 7.

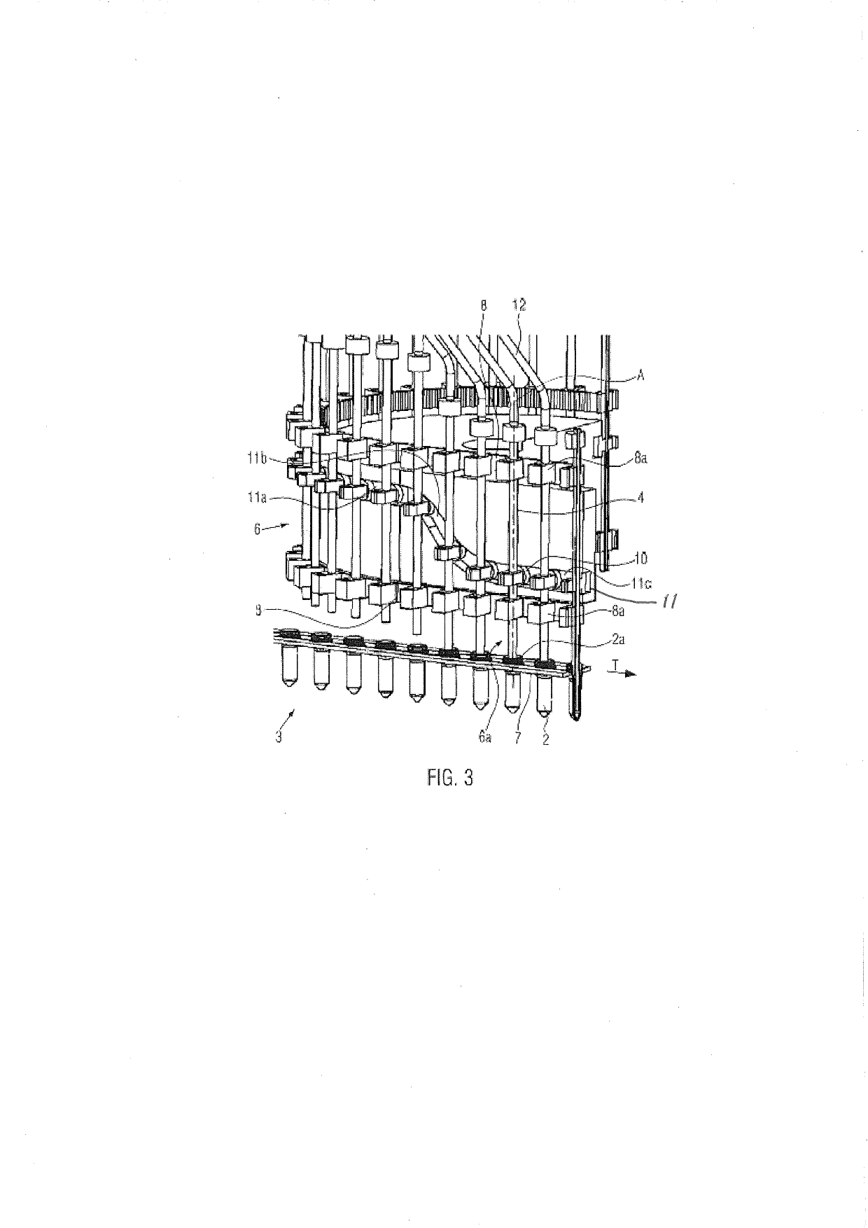

In FIG. 3, a perspective partial view of the lances 4 with guide rollers 10 and a cam curve 11 of the rinser 1 according to the disclosure of FIG. 1 can be seen. Here, several lances 4 are each held in two guide elements 8a of the two toothed belts 8. Here, the cylindrical bores are aligned in the guide elements 8a, such that the lances 4 can be smoothly moved upwards and downwards inside them along their axes. The lances 4 are each connected with a guide roller 10 which rolls in the cam curve 11.

The cam curve 11 is designed here such that it initially has a higher horizontal region 11a which passes over into a lower horizontal region 11c via an oblique region 11b. In the continuous motion of the lances 4 in the direction of transport T, the guide rollers 10 move within the cam curve 11. Thus, each lance 4 is moved in an upper position by its guide roller 10 in the region of the higher horizontal region 11a of the cam curve, and subsequently lowered down via the region 11b. When the guide roller 10 is moving in the region of the lower horizontal cam curve 11c, the corresponding lance is lowered down into the corresponding container 2 to just above the bottom of the latter. In the region of the lower horizontal cam curve 11c, the cleansing agent is then introduced into the container 2. Thereby, a directed guidance of the flow of the cleansing agent within the container 2 and a calculable cleaning effect are achieved. In the further procedure, the lance 4 is then lifted again by the guide roller 10 in the cam curve 11 (not represented here).

Here, too, one hose 12 supplying the lance 4 with compressed air is associated with each lance 4. The hose 12 is flexible, so that the lance 4 can be guided upwards and downwards. Moreover, a length adjustment between the rotary distributor 13 and the transport path 6 is effected by the flexible hose 12.

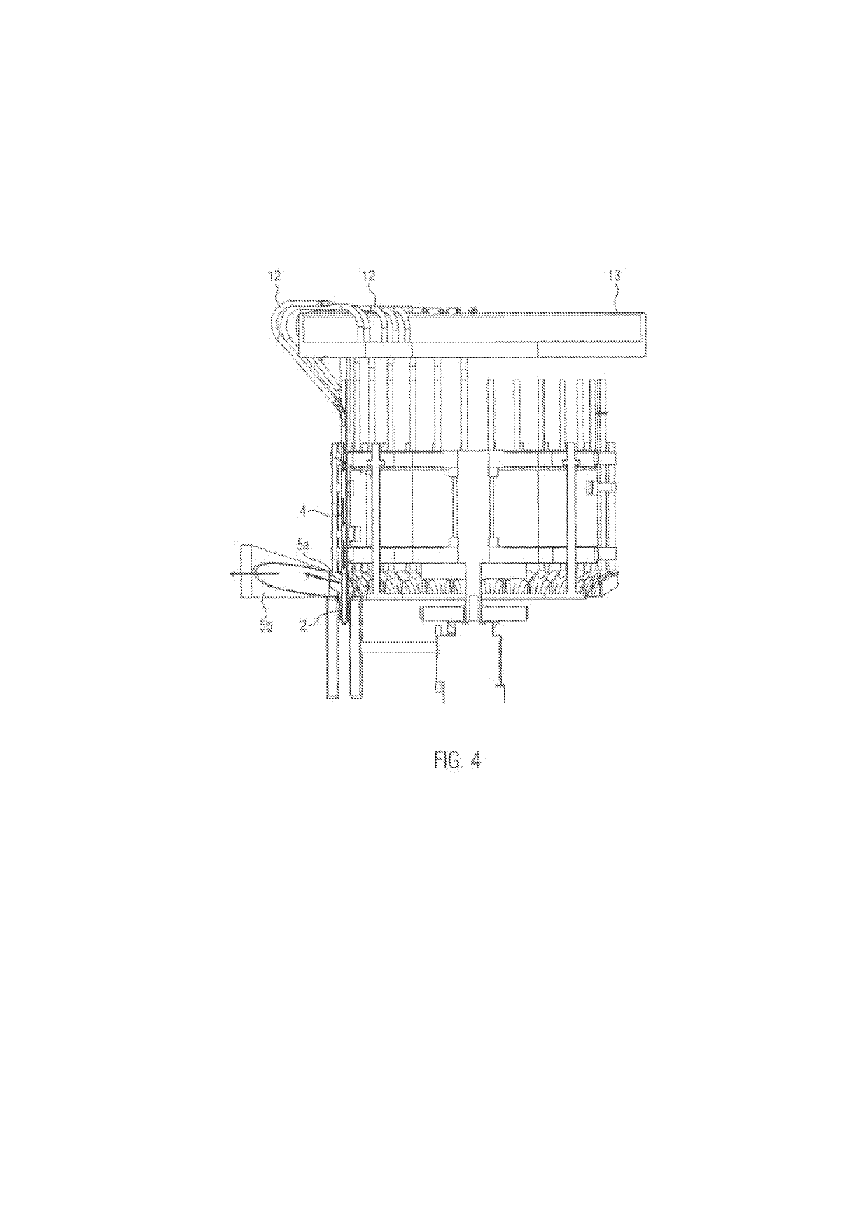

FIG. 4 shows a sectional view of the rinser 1 according to the disclosure of FIG. 1 in a lateral representation. One can see the course of the flow of the ionized air within the system.

First, the hoses 12 are supplied with compressed air via the rotary distributor 13. The upper end of the lance 4 is here connected with the lower end of the hose 12. Thereby, the compressed air is pressed into the lance 4. At the lower end of the lance 4, the now already ionized air flows into the container 2 near the bottom. Between the container wall and the lance, ionized air flows again upwards and is sucked off with the suction hood 5a and the suction funnel 5b. Thereby, a very efficient cleaning of the containers 2 from foreign particles is achieved.

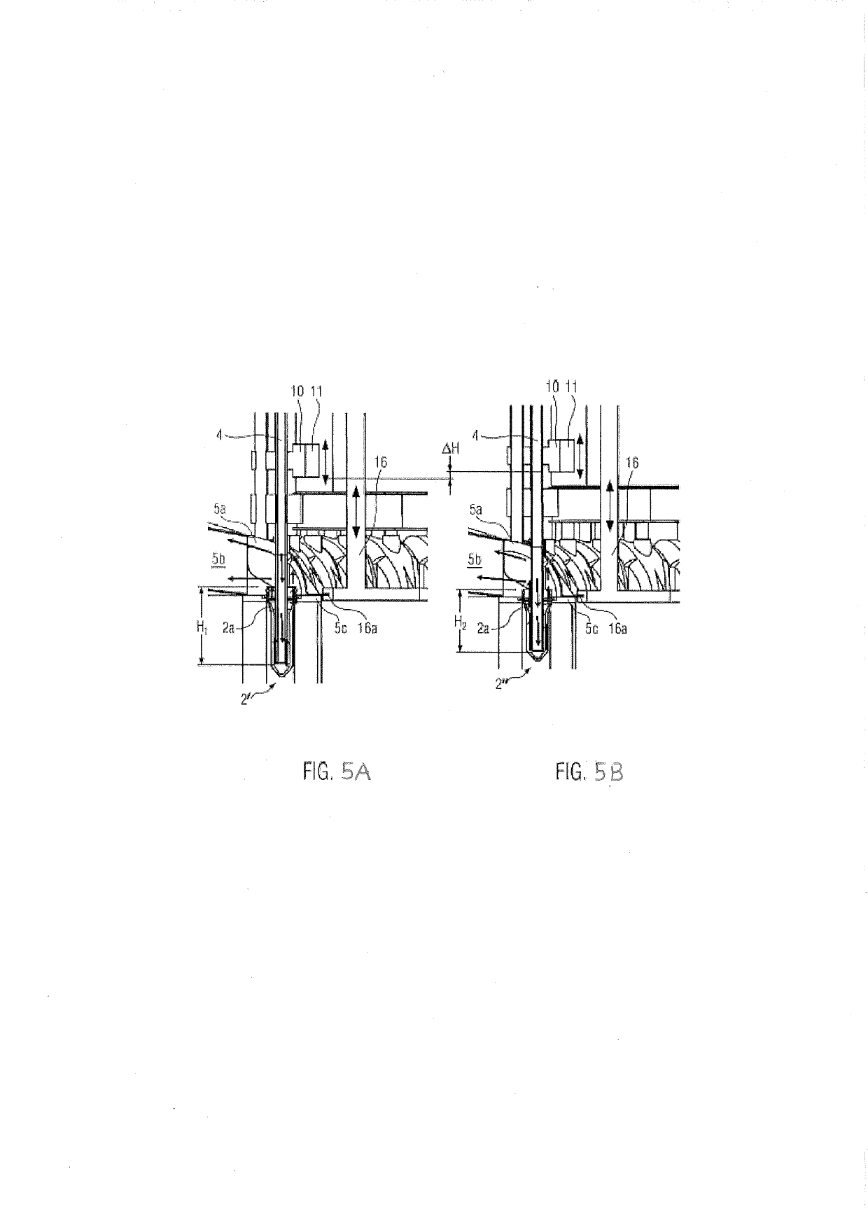

FIGS. 5A and 5B show a detailed view of the rinser according to the disclosure of FIG. 1 for illustrating the height adjustment of the lances 4 and the suction hoods 5a in a sectional view. One can see in the two FIGS. 5A, 5B how the immersion depth H1, H2 of the lances 4 into the two containers 2′ and 2″ of different lengths is adapted via a height adjustment of the cam curve 11. The containers 2′, 2″ here have the same basic shape, but differ as to their lengths.

The cam curve 11 is designed to be height adjustable, so that it can be shifted as a whole to the top or bottom along the vertical line. Correspondingly, the path of the guide roller 10 is offset by the cam curve 11 such that the lance 4 connected to it submerges into the container 2′, 2″ to near the container's bottom. In the two configurations, the cam curve 11 is adjusted vertically with respect to each other by a vertical offset ΔH.

Simultaneously, the height of the suction hoods 5a must be adjusted such that the suction hoods 5a end at the container mouths 2a in both container types 2′, 2″. This permits a particularly good suction efficiency. The suction hoods 5a each have a guide end 5c which is guided in a groove 16a of a guide rail 16. The guide rail 16 is designed to be height adjustable so that the height of the guide groove 16a can be adapted to the level of the container mouth 2a.

The air flow exiting from the container 2′, 2″ is forwarded to the suction funnels 5b via the suction hoods 5a, and thus an optimal cleaning effect is achieved in containers of different sizes.

It will be understood that features mentioned in the above described embodiments are not restricted to these special combinations and are also possible in any other combinations.

What is claimed is:

1. A rinser for cleaning containers, comprising
a linear conveyor path for conveying the containers;
lances which are inserted into the containers for supplying at least one cleansing agent; and
at least one suction device for sucking off the supplied cleansing agent from the containers,
wherein the lances are arranged at a closed cyclic transport path; and
the transport path comprises a linear section which corresponds to the conveyor path for supplying the cleansing agent.

2. A rinser for cleaning containers according to claim 1, wherein the transport path is designed in the region of the linear section such that longitudinal axes of the lances correspond to the mouths of the containers while they are being conveyed.

3. A rinser for cleaning containers according to claim 1, wherein the conveyor path comprises container seats by which the containers are continuously conveyed.

4. A rinser for cleaning containers according to claim 1, wherein the transport path comprises at least one toothed belt at which the lances are arranged.

5. A rinser for cleaning containers according to claim 4, wherein the toothed belt runs over at least two belt rollers, and wherein the linear section of the transport path is formed with a run of the toothed belt located between the two belt rollers.

6. A rinser for cleaning containers according to claim 1, wherein the transport path comprises guide elements in which the lances are held to be shifting along their longitudinal axes.

7. A rinser for cleaning containers according to claim 1, wherein the lances comprise guide rollers which roll in a cam curve for controlling their longitudinal movement.

8. A rinser for cleaning containers according to claim 7, wherein the cam curve is designed to be height adjustable for adjusting an immersion depth of the lances into the containers.

9. A rinser for cleaning containers according to claim 1, wherein the lances are connected to a rotary distributor via hoses and/or cables, in particular and wherein the rotary distributor is synchronized with respect to the transport path via a transmission.

10. A rinser for cleaning containers according to claim 8, wherein the suction device comprises suction hoods associated with the lances and which are adjustable for the height adjustment to the conveyor path.

11. A rinser for cleaning containers according to claim 6, wherein the suction hoods are connected with the guide elements of the transport path in a height adjustable manner.

12. A rinser for cleaning containers according to claim 1, wherein the conveyor path and the transport path are connected with a transmission and the transmission is driven via a drive motor.
